(19) United States
(12) Patent Application Publication
(10) Pub. No.: US 2006/0046938 A1
(43) Pub. Date: Mar. 2, 2006

(54) Methods and compositions for delinking crosslinked fluids

(76) Inventors: Philip C. Harris, Duncan, OK (US); Rajesh K. Saini, Duncan, OK (US); Bradley L. Todd, Duncan, OK (US)

Correspondence Address: Robert A. Kent;Halliburton Energy Services, 2600 S. 2nd Street, Duncan, OK, 73536-0440, US

(21) Appl. No.: 10/932,749

(22) Filed: Sep. 2, 2004

(51) Int. Cl. C09K 8/60; E21B 43/00

(52) U.S. Cl. 507/219

(57) ABSTRACT

One embodiment of the present invention provides a method of treating a subterranean formation comprising introducing to a portion of a subterranean formation a slurry comprising a solid, particulate chelating agent substantially coated with a degradable material and a viscosified treatment fluid comprising a crosslinked gelling agent, allowing the degradable material to degrade and release the chelating agent into the viscosified treatment fluid; and, allowing the released chelating agent to delink at least a portion of the crosslinked gelling agent. Another embodiment provides a delinker for use in a viscosified treatment fluid comprising a crosslinked gelling agent, comprising a particulate chelating agent substantially coated with a degradable material wherein the degradable material is capable of degrading to release the chelating agent and wherein the released chelating agent is then capable of delinking at least a portion of the crosslinked gelling agent.

### BACKGROUND OF THE INVENTION

The present invention relates to compositions and methods for use in subterranean formations. More specifically, the present invention relates to compositions and methods for delinking crosslinked fluids used in subterranean applications using chelating agents.

Viscosified treatment fluids are used in a variety of operations in subterranean formations. For example, viscosified treatment fluids have been used as drilling fluids, fracturing fluids, and gravel packing fluids. Viscosified treatment fluids generally have a viscosity that is sufficiently high to suspend particulates for a desired period of time, to transfer hydraulic pressure, and/or to prevent undesired leak-off of fluids into the formation.

Most viscosified treatment fluids include gelling agent molecules that are crosslinked to increase their viscosity. The gelling agents typically used in viscosified treatment fluids are usually biopolymers or synthetic polymers. Common gelling agents include, inter alia, galactomannan gums, cellulosic polymers, and polysaccharides. The crosslinking between gelling agent molecules occurs through the action of a crosslinker. Conventional crosslinkers generally comprise boron, aluminum, antimony, zirconium, magnesium, or titanium.

In some applications, e.g., in subterranean well operations, after a viscosified treatment fluid has performed its desired function, the fluid may be “broken,” meaning that its viscosity is reduced. Breaking a viscosified treatment fluid may make it easier to remove the viscosified treatment fluid from the subterranean formation, a step that generally is completed before the well is returned to production. The breaking of viscosified treatment fluids is usually accomplished by incorporating “breakers” into the viscosified treatment fluids. Traditional breakers include, inter alia, enzymes, oxidizers, and acids. As an alternative to using traditional breakers, a viscosified treatment fluid may break naturally if given enough time and/or exposure to a sufficient temperature. This may be problematic, however, as it may increase the amount of time before the well may be returned to production.

In some situations, the use of traditional breakers is associated with premature and/or incomplete viscosity reduction. This may be problematic. For example, in a fracturing operation, a viscosified treatment fluid may be introduced into a subterranean formation at a pressure sufficient to create or enhance at least one fracture therein. Premature viscosity reduction can decrease the quantity and/or length of fractures generated within the formation, and therefore may decrease the likelihood that the fracturing operation will result in enhanced production. In addition, premature viscosity reduction can cause particulates like proppants to settle out of the fluid in an undesirable location and/or at an undesirable time. Traditional breakers also can be problematic in that they may chemically degrade gelling agents. As a result, pieces of the degraded gelling agent may adhere to the formation, clogging the pore throats of the formation, and thereby potentially impacting the production of desirable fluids. Moreover, the degradation of gelling agents prevents them from being reused.

### SUMMARY OF THE INVENTION

The present invention relates to compositions and methods for use in subterranean formations. More specifically, the present invention relates to compositions and methods for delinking crosslinked fluids used in subterranean applications using chelating agents.

One embodiment of the present invention provides a method of delayed delinking of a crosslinked fluid comprising mixing a solid, particulate chelating agent substantially coated with a degradable material into a viscosified treatment fluid comprising a crosslinked gelling agent to create a slurry, allowing the degradable material to degrade and release the chelating agent into the viscosified treatment fluid; and, allowing the released chelating agent to delink at least a portion of the crosslinked gelling agent.

Another embodiment of the present invention provides a method of treating a subterranean formation, comprising introducing to a portion of a subterranean formation a slurry comprising a solid, particulate chelating agent substantially coated with a degradable material and a viscosified treatment fluid comprising a crosslinked gelling agent, allowing the degradable material to degrade and release the chelating agent into the viscosified treatment fluid; and, allowing the released chelating agent to delink at least a portion of the crosslinked gelling agent.

Another embodiment of the present invention provides a servicing fluid slurry for use in subterranean formations, comprising a viscosified treatment fluid comprising a crosslinked gelling agent and a solid, particulate chelating agent substantially coated with a degradable material wherein the degradable material is capable of degrading to release the chelating agent and wherein the released chelating agent is then capable of delinking at least a portion of the crosslinked gelling agent.

Another embodiment of the present invention provides a delinker for use in a viscosified treatment fluid comprising a crosslinked gelling agent, comprising a particulate chelating agent substantially coated with a degradable material wherein the degradable material is capable of degrading to release the chelating agent and wherein the released chelating agent is then capable of delinking at least a portion of the crosslinked gelling agent.

The features and advantages of the present invention will be readily apparent to those skilled in the art upon a reading of the description of the preferred embodiments that follows.

### DESCRIPTION OF PREFERRED EMBODIMENTS

The present invention relates to compositions and methods for use in subterranean formations. More specifically, the present invention relates to compositions and methods for delinking crosslinked fluids used in subterranean applications using chelating agents. The methods and compositions of the present invention are useful in a variety of applications wherein it is desirable to reduce the viscosity of a viscosified treatment fluid. Examples include, but are not limited to, subterranean applications such as fracturing and gravel packing. The delinking compositions of the present invention, in certain embodiments, may allow for recovery and reuse of viscosified treatment fluids, rather than necessitating disposal of such fluids. Such reuse includes the reuse of the viscosified treatment fluid in its entirety, or any individual component or combination of components thereof. The ability to reuse viscosified treatment fluids may offer considerable cost savings as compared to single-use conventional fluids. Reuse of viscosified treatment fluids, inter alia, may reduce the environmental impact associated with the water and chemical demand of viscosified treatment fluids used in subsequent operations, as well as the associated waste disposal costs.

In certain embodiments, the delinking action of the chelating agent may be delayed by encapsulating the agent with a degradable material, such as an aliphatic polyester. In such embodiments the degradable material gradually degrades to release the chelating agent down hole. Preferably, the chelating agent is not substantially released until the subterranean treatment is substantially complete. The delinking compositions of the present invention are well-suited for use with metallic-crosslinked viscosified treatment fluids, such as those that feature zirconium, titanium, chromium, barium, calcium, cerium, cobalt, copper, iron, magnesium, manganese, nickel, strontium, or zinc crosslinking agents. The delinking compositions of the present invention are beneficial in part because they are less likely to decompose or to incompletely or prematurely delink a viscosified treatment fluid. Incomplete delinking can result in the creation of an undesirable residue in the fluid and on the face of the formation. Furthermore, chelating agents are well suited for delinking crosslinked synthetic polymers and are suitable for use over a broad range of temperatures.

Generally, any metallic-crosslinked subterranean treatment fluid suitable for a fracturing, gravel packing, or frac-packing application may be used in accordance with the teachings of the present invention. In exemplary embodiments of the present invention, the fluids are aqueous gels comprised of water, a gelling agent for gelling the water and increasing its viscosity, and a crosslinking agent for crosslinking the gel and increasing the viscosity of the fluid. The increased viscosity of the gelled, or gelled and crosslinked, fluid, inter alia, reduces fluid loss and, where desired, may allow the fluid to transport significant quantities of suspended particulates. The water used to form the aqueous gelled fluid may be fresh water, salt water, brine, an alcohol/water mixture, or any other aqueous liquid that does not adversely react with the other components.

A variety of gelling agents may be used, including hydratable polymers that contain one or more functional groups such as hydroxyl, carboxyl, sulfate, sulfonate, amino, or amide groups. Particularly useful are polysaccharides and derivatives thereof that contain one or more of the monosaccharide units galactose, mannose, glucoside, glucose, xylose, arabinose, fructose, glucuronic acid, or pyranosyl sulfate. Examples of natural hydratable polymers containing the foregoing functional groups and units that are particularly useful in accordance with the present invention include, but are not limited to, guar, guar derivatives, hydroxypropyl guar, carboxymethyl guar, xanthan, chitosan, schleroglucan, succinoglycan, starch, biopolymers, and hydroxyethyl cellulose. Hydratable synthetic polymers and copolymers that contain the above-mentioned functional groups may also be used. Examples of such synthetic polymers include, but are not limited to, poly(acrylamido-methyl-propane sulfonate), polyacrylate, polymethacrylate, polyacrylamide, poly(vinyl alcohol), and polyvinylpyrrolidone. The chosen gelling agent is generally combined with the water in the fracturing fluid in an amount in the range of from about 0.01% to about 3% by weight of the water, preferably 0.01% to about 2% by weight of the water.

Examples of crosslinking agents that can be used include compounds that are capable of releasing multivalent metal ions. Examples of multivalent metal ions in suitable crosslinking agents include zirconium, titanium, chromium, barium, calcium, cerium, cobalt, copper, iron, magnesium, manganese, nickel, strontium, or zinc. When used, the crosslinking agent is generally added to the gelled water in an amount in the range of from about 0.01% to about 10% by weight of the water, preferably 0.01% to about 5% by weight of the polymer. One skilled in the art will recognize that suitable crosslinking agents may contain as little as 2% or as much as 15% of the metal component that acts as the active portion of the crosslinker.

The crosslinked fluids used in the present invention may also include one or more of a variety of well-known additives, such as gel stabilizers, fluid loss control agents, surfactants, clay stabilizers, bactericides, and the like. In addition, the crosslinked fluids used in the present invention may also include traditional breakers (i.e., oxidizing) for use in conjunction with the chelating agent delinkers of the present invention. For example, the use of oxidizing breakers in conjunction with a chelating delinker may be preferred when breaking carbohydrate polymers.

The present invention involves the use of a chelating agent as a delinker. Generally, a chelating agent is a substance whose molecules can form several bonds to a single metal ion, or, in other words, is a multidentate ligand. Any chelating agent that binds the metal used to create the crosslink (such as zirconium, titanium, chromium, barium, calcium, cerium, cobalt, copper, iron, magnesium, manganese, nickel, strontium, or zinc) may be acceptable for use in the present invention. In particular embodiments of the present invention the chelating agent comprises ethylenediamine tetraacetic acid (“EDTA”). Other chelating agents suitable for use in the present invention include, but are not limited to, sodium tripolyphospate, nitrilotriacetic acid, gluconic acid, citric acid, diglycolic acid, diethylenetriamine, diaminopropanetetraacetic acid, and (aminoethyl)ethylene glycol tetraacetic acid; and salts of the above mentioned chelates. Additional information on suitable chelating agents may be found in the ENCYCLOPEDIA OF CHEMICAL TECHNOLOGY, VOL 5, “Chelating Agents,” pp. 764-795 by Kirk-Othmer, the relevant portion of which is hereby incorporated by reference herein.

When used to delink viscosified, crosslinked treatment fluids, chelating agents preferentially bind with the metal ions used to form the crosslinks between the polymers in the crosslinked fluid, breaking the crosslinking bonds in the process. The amount of chelating agent necessary to break the crosslinks may vary, depending, inter alia, on the particular metal ion used to crosslink the polymer and the selected chelating agent. For example, in determining the amount of chelating agent needed to successfully de-crosslink a polymer, one skilled in the art may consider the number of potential binding sites on the metal ion used to crosslink the polymer (for example, zirconium has six potential binding sites) and the number of potential binding sites in the chosen chelating agents (for example, EDTA is a hexadentate ligand, providing six binding sites, whereas citric acid is tridentate ligand, providing three binding sites). Generally, to fully break a crosslink, stoichiometry will dictate that the number of binding sites in the chelating agent is aligned 1:1 with the number of binding sites of the crosslinking metal ion. For example, a 1:1 stoichiometric ratio between EDTA and a zirconium crosslink may be suitable. Of course, one skilled in the art, with the benefit of this disclosure, will recognize the need to consider the equilibrium constant, or binding constant, of the crosslink as well. For example, a terpolymer (60% AMPS, 39.5% acrylamide, 0.5% acrylic acid) crosslinked with zirconium may be so strongly crosslinked that tridentate ligands may not be suitable to delink the fluid even given a 2:1, 4:1, or even 6:1 stoichiometric ratio.

In order to control the release of the chosen chelating agent into the fracturing fluid, embodiments of the present invention at least partially coat the chelating agent with a degradable material, such as an aliphatic polyester. This helps minimize, or at least reduce, the possibility that the chelating agent may prematurely delink the fracturing fluid.

Generally, suitable degradable materials used in the present invention are materials capable of undergoing an irreversible degradation down hole. As referred to herein, the term “irreversible” will be understood to mean that the degradable material, once degraded down hole, should not reconstitute while down hole, e.g., the degradable material should degrade in situ but should not reconstitute in situ. The terms “degradation” or “degradable” refer to oxidative degradation, hydrolytic degradation, enzymatic degradation, or thermal degradation that the degradable material may undergo. In hydrolytic degradation, the degradable particulate degrades, or dissolves, when exposed to water. Non-limiting examples of degradable materials that may be used in conjunction with the present invention include, but are not limited to aromatic polyesters and aliphatic polyesters. Such polyesters may be linear, graft, branched, crosslinked, block, star shaped, dendritic, etc. Some suitable polyesters include poly(hydroxy alkanoate) (PHA); poly(alpha-hydroxy) acids such as poly(lactic acid) (PLA), poly(gylcolic acid) (PGA), polylactide, and polyglycolide; poly(beta-hydroxy alkanoates) such as poly(beta-hydroxy butyrate) (PHB) and poly(beta-hydroxybutyrates-co-beta-hydroxyvelerate) (PHBV); poly(omega-hydroxy alkanoates) such as poly(beta-propiolactone) (PPL) and poly(ε-caprolactone) (PCL); poly(alkylene dicarboxylates) such as poly(ethylene succinate) (PES), poly(butylene succinate) (PBS); and poly(butylene succinate-co-butylene adipate); polyanhydrides such as poly(adipic anhydride); poly(orthoesters); polycarbonates such as poly(trimethylene carbonate); and poly(dioxepan-2-one). Derivatives of the above materials may also be suitable, in particulare, derivative that have added functional groups that may help control degradaton rates.

The rate at which the degradable material degrades may depend on, inter alia, other chemicals present, temperature, and time. Furthermore, the degradability of the degradable material depends, at least in part, on its structure. For instance, the presence of hydrolyzable and/or oxidizable linkages often yields a material that will degrade as described herein. The rates at which such degradable materials degrade are dependent on factors such as, but not limited to, the type of repetitive unit, composition, sequence, length, molecular geometry, molecular weight, morphology (e.g., crystallinity, size of spherulites, and orientation), hydrophilicity, hydrophobicity, surface area, and additives. The manner in which the degradable material degrades also may be affected by the environment to which the polymer is exposed, e.g., temperature, presence of moisture, oxygen, microorganisms, enzymes, pH, and the like.

A variety of processes may be used to prepare degradable polymers that are suitable for use in the crosslinked fluids of the present invention. Examples of such processes include, but are not limited to, polycondensation reactions, ring-opening polymerizations, free radical polymerizations, anionic polymerizations, carbocationic polymerizations, coordinative ring-opening polymerizations, and any other appropriate processes.

A number of encapsulation methods are suitable for at least partially coating the chelating agents in accordance with the present invention. Generally, the encapsulation methods of the present invention are capable of delaying the release of the chelating agent for at least about 30 minutes, preferably about one hour. Some suitable encapsulation methods comprise known microencapsulation techniques including known fluidized bed processes. One such fluidized bed process is known in the art as the Wüirster process. A modification of this process uses a top spray method. Equipment to effect such microencapsulation is available from, for example, Glatt Air Techniques, Inc., Ramsey, N.J. Additional methods of coating the chelating agent may be found in U.S. Pat. No. 6,123,965 issued to Jacob, et al. Typically, these encapsulation methods are used to apply a coating of from about 20% by weight to about 30% by weight, but they may be used to apply a coating anywhere ranging from about 1% by weight to about 50% by weight. Generally, the amount of coating depends on the chosen coating material and the purpose of that material.

The methods of the present invention provide novel materials for delaying the release of the chelating agent by coating that agent with a degradable material. Many commercially available chelating agents are ill-suited for encapsulation using traditional methods. For example, EDTA is widely commercially available in the form of a powder that is not suitable for encapsulation using traditional micro encapsulation methods (e.g., fluidized bed methods). However, larger solid particles of EDTA, such as agglomerated EDTA powder, may be encapsulated using these traditional methods. Therefore, to facilitate the encapsulation of the chelating agent, particular embodiments of the present invention may agglomerate or pelletize the chelating agent prior to coating the chelating agent with the degradable material. This agglomeration or pelletization allows chelating agents that may not typically be compatible with traditional encapsulation methods (e.g., chelating agents in powdered form or those lacking a smooth exterior) to be encapsulated using traditional methods. A number of agglomeration and/or pelletization methods are suitable for use in the present invention. One suitable method involves using a Glatt machine along with a binder. The binder may be water, an oil, a surfactant, a polymer, or any other material that can be sprayed and cause the particles to stick together, either temporarily or permanently. Generally, when a temporary binder (such as water) is used the agglomeration process is followed by a sprayed-on coating process to coat the pelletized chelating agent with a degradable material.

Another method of coating the chelating agent within a degradable material is to physically mix the chelating agent with the degradable material and to form a single, solid particle comprising both materials. One way of accomplishing such a task is to take a powder form chelating agent and to mix it with a melted degradable polymer and then to extrude the mixture into the form of pellets. The mixture can be formed by any number of means commonly employed to produce mixtures of thermoplastics and other components, for example by using a single screw or twin screw extruder, roll mill, Banbury mixer, or the like. The mixture can be made by melting the degradable material and adding the chelating agent as a solid or a liquid, or the components can be added simultaneously. The chelating agent can be present in the particle as either a homogeneous solid state solution or as discrete particles of chelating agent in the degradable particle. The particles may be washed in water or some other solvent in order to remove particles of chelating agent on the surface of the pellet.

Generally, the crosslinked fluids of the present invention are suitable for use in hydraulic fracturing, frac-packing, and gravel packing applications. In exemplary embodiments of the present invention where the crosslinked fluids are used to carry particulates, the particulates are generally of a size such that formation fines that may migrate with produced fluids are prevented from being produced from the subterranean zone. Any suitable particulate may be used, including graded sand, bauxite, ceramic materials, glass materials, walnut hulls, polymer beads, and the like. Generally, the particulates have a size in the range of from about 4 to about 400 mesh, U.S. Sieve Series. In some embodiments of the present invention, the particulate is graded sand having a particle size in the range of from about 10 to about 70 mesh, U.S. Sieve Series. In particular embodiments of the present invention, the proppant may be at least partially coated with a curable resin, tackifying agents, or some other flowback control agent or formation fine control agent.

To facilitate a better understanding of the present invention, the following examples of preferred embodiments are given. In no way should the following examples be read to limit or define the scope of the invention.

### EXAMPLES

Base gel fluid was mixed in a Waring Blender by dissolving 0.5% terpolymer (comprising 60% AMPS, 39.5% acrylamide, 0.5% acrylic acid) in 2% KCl in tap water. The pH was adjusted to pH 5, an encapsulated delinker was added at a variety of concentrations, and a zirconium crosslinker was added at 0.03% by weight. The encapsulated delinker comprised 30% by weight EDTA coated with 70% by weight poly(lactic acid).

High temperature viscosity measurements were made on a Fann 50 viscometer equipped with a 420 spring, a 316SS cup and B5X bob. The bath was preheated to test temperature (350° F.). A 35 mL sample of gel fluid was transferred to the viscometer cup at 75° F. and placed on the viscometer. The cup was rotated at 47 rpm—40 sec⁻¹. Viscosity in centipoise at 40 sec⁻¹ was recorded against test time. The weight of “breaker” described below refers to the total weight of the coated breaker—that is, the EDTA weight plus the weight of the poly(lactic acid) coating.

TABLE 1
Effect on viscosity of various levels of encapsulated delinker.

| | Breaker Concentration | | | | |
|---|---|---|---|---|---|
| | 0 lb/1000 gal | 8 lb/1000 gal | 16 lb/1000 gal | 33 lb/1000 gal | 50 lb/1000 gal |
| Time(min) | Vis(40/s) | Vis(40/s) | Vis(40/s) | Vis(40/s) | Vis(40/s) |
| 12 | 880 | 616 | 546 | 440 | 318 |
| 25 | 893 | 462 | 354 | 274 | 220 |
| 38 | 784 | 361 | 176 | 48 | 36 |
| 51 | 683 | 296 | 124 | 30 | 17 |
| 64 | 597 | 258 | 89 | 24 | 12 |
| 77 | 545 | 234 | 70 | 20 | 8 |
| 90 | 454 | 207 | 60 | 17 | |
| 103 | 398 | 182 | 55 | | |
| 117 | 358 | 151 | 49 | | |
| 130 | 250 | 116 | 44 | | |

As is clearly shown in Table 1, above, the encapsulated delinker was successful in reducing the viscosity of the crosslinked fluid,

Therefore, the present invention is well adapted to attain the ends and advantages mentioned as mentioned as well as those that are inherent therein. While numerous changes may be made by those skilled in the art, such changes are encompassed within the spirit of this invention as defined by the appended claims.

What is claimed is:

1. A method of delayed delinking of a crosslinked fluid comprising:
mixing a solid, particulate chelating agent substantially coated with a degradable material into a viscosified treatment fluid comprising a crosslinked gelling agent to create a slurry,
allowing the degradable material to degrade and release the chelating agent into the viscosified treatment fluid; and,
allowing the released chelating agent to delink at least a portion of the crosslinked gelling agent.

2. The method of claim 1 wherein the chelating agent is capable of binding zirconium, titanium, chromium, barium, calcium, cerium, cobalt, copper, iron, magnesium, manganese, nickel, strontium, zinc, or a combination thereof.

3. The method of claim 1 wherein the chelating agent comprises ethylenediaminetetraacetic acid, sodium tripolyphospate, nitrilotriacetic acid, gluconic acid, citric acid, diglycolic acid, diethylenetriamine, diaminopropanetetraacetic acid, (aminoethyl)ethylene glycol tetraacetic acid, the salts of the above acids, or a combination thereof.

4. The method of claim 1 wherein the degradable material is transformable from a solid state to an irreversible liquid state or soluble state by oxidative degradation, hydrolytic degradation, thermal degradation, enzymatic degradation, or a combination thereof.

5. The method of claim 1 wherein the degradable material comprises an aliphatic polyester, an aromatic polyester, a polyanhydride, a poly(orthoester), a polycarbonate, a poly(dioxepan-2-one) or a combination thereof.

6. The method of claim 5 where the degradable material is copolymerized, block copolymerized, blended with hydrophilic polymers or hydrophobic polymers to control the degradable material's rate of degradation.

7. The method of claim 1 wherein the degradable material comprises poly(lactic acid).

8. The method of claim 1 wherein the chelating agent is at least partially agglomerated into pellets prior to being substantially coated with the degradable material.

9. The method of claim 1 wherein the fracturing fluid comprises a metallic crosslinking agent.

10. A method of treating a subterranean formation, comprising:
introducing to a portion of a subterranean formation a slurry comprising a solid, particulate chelating agent substantially coated with a degradable material and a viscosified treatment fluid comprising a crosslinked gelling agent,
allowing the degradable material to degrade and release the chelating agent into the viscosified treatment fluid; and,
allowing the released chelating agent to delink at least a portion of the crosslinked gelling agent.

11. The method of claim 10 wherein the chelating agent is capable of binding zirconium, titanium, chromium, barium, calcium, cerium, cobalt, copper, iron, magnesium, manganese, nickel, strontium, zinc, or a combination thereof.

12. The method of claim 10 wherein the chelating agent comprises ethylenediaminetetraacetic acid, sodium tripolyphospate, nitrilotriacetic acid, gluconic acid, citric acid, diglycolic acid, diethylenetriamine, diaminopropanetetraacetic acid, (aminoethyl)ethylene glycol tetraacetic acid, the salts of the above acids, or a combination thereof.

13. The method of claim 10 wherein the degradable material is transformable from a solid state to an irreversible liquid state or soluble state by oxidative degradation, hydrolytic degradation, thermal degradation, enzymatic degradation, or a combination thereof.

14. The method of claim 10 wherein the degradable material comprises an aliphatic polyester, an aromatic polyester, a polyanhydride, a poly(orthoester), a polycarbonate, a poly(dioxepan-2-one) or a combination thereof.

15. The method of claim 10 where the degradable material is copolymerized, block copolymerized, blended with hydrophilic polymers or hydrophobic polymers to control the degradable material's rate of degradation

16. The method of claim 10 wherein the degradable material comprises poly(lactic acid).

17. The method of claim 10 wherein the chelating agent is at least partially agglomerated into pellets prior to being at least partially coated with the degradable material.

18. The method of claim 10 wherein the fracturing fluid contains a metallic crosslinking agent.

19. The method of claim 10 wherein the crosslinked fracturing fluid further comprises proppant.

20. The method of claim 18 wherein the proppant is at least partially coated with a curable resin.

21. The method of claim 18 wherein the proppant is at least partially coated with a tackifying agent.

22. A servicing fluid slurry for use in subterranean formations, comprising a viscosified treatment fluid comprising a crosslinked gelling agent and a solid, particulate chelating agent substantially coated with a degradable material wherein the degradable material is capable of degrading to release the chelating agent and wherein the released chelating agent is then capable of delinking at least a portion of the crosslinked gelling agent.

23. The servicing fluid slurry of claim 22 wherein the crosslinked gelling agent comprises a metallic crosslinking agent.

24. The servicing fluid slurry of claim 22 further comprising a proppant material.

25. The servicing fluid slurry of claim 22 wherein the chelating agent is capable of binding zirconium, titanium, chromium, barium, calcium, cerium, cobalt, copper, iron, magnesium, manganese, nickel, strontium, zinc, or a combination thereof.

26. The servicing fluid slurry of claim 22 wherein the chelating agent comprises ethylenediaminetetraacetic acid, sodium tripolyphospate, nitrilotriacetic acid, gluconic acid, citric acid, diglycolic acid, diethylenetriamine, diaminopropanetetraacetic acid, (aminoethyl)ethylene glycol tetraacetic acid, the salts of the above acids, or a combination thereof.

27. The servicing fluid slurry of claim 22 wherein the degradable material is transformable from a solid state to an irreversible liquid state or soluble state by oxidative degradation, hydrolytic degradation, thermal degradation, enzymatic degradation, or a combination thereof.

28. The servicing fluid slurry of claim 22 wherein the degradable material comprises an aliphatic polyester, an aromatic polyester, a polyanhydride, a poly(orthoester), a polycarbonate, a poly(dioxepan-2-one) or a combination thereof.

29. The servicing fluid slurry of claim 22 where the degradable material is copolymerized, block copolymerized, blended with hydrophilic polymers or hydrophobic polymers to control the degradable material's rate of degradation

30. The servicing fluid slurry of claim 22 wherein the degradable material comprises poly(lactic acid).

31. The servicing fluid of claim 22 wherein the chelating agent is at least partially agglomerated into pellets prior to being at least partially coated with the degradable material.

32. The servicing fluid slurry of claim 31 wherein the proppant material is at least partially coated with a curable resin.

33. The servicing fluid slurry of claim 31 wherein the proppant material is at least partially coated with a tackifying agent.

34. A delinker for use in a viscosified treatment fluid comprising a crosslinked gelling agent, comprising a particulate chelating agent substantially coated with a degradable material wherein the degradable material is capable of degrading to release the chelating agent and wherein the released chelating agent is then capable of delinking at least a portion of the crosslinked gelling agent.

35. The delinker of claim 34 wherein the chelating agent is capable of binding zirconium, titanium, chromium, barium, calcium, cerium, cobalt, copper, iron, magnesium, manganese, nickel, strontium, zinc, or a combination thereof.

36. The delinker of claim 34 wherein the chelating agent comprises ethylenediaminetetraacetic acid, sodium tripolyphospate, nitrilotriacetic acid, gluconic acid, citric acid, diglycolic acid, diethylenetriamine, diaminopropanetetraacetic acid, (aminoethyl)ethylene glycol tetraacetic acid, the salts of the above acids, or a combination thereof.

37. The delinker of claim 34 wherein the degradable material is transformable from a solid state to an irreversible liquid state or soluble state by oxidative degradation, hydrolytic degradation, thermal degradation, enzymatic degradation, or a combination thereof.

38. The delinker of claim 34 wherein the degradable material comprises an aliphatic polyester, an aromatic polyester, a polyanhydride, a poly(orthoester), a polycarbonate, a poly(dioxepan-2-one) or a combination thereof.

39. The delinker of claim 34 where the degradable material is copolymerized, block copolymerized, blended with hydrophilic polymers or hydrophobic polymers to control the degradable material's rate of degradation

40. The delinker of claim 34 wherein the degradable material comprises poly(lactic acid).

41. The delinker of claim 34 wherein the chelating agent is at least partially agglomerated into pellets prior to being at least partially coated with the degradable material.
